(19) United States
(12) Patent Application Publication
(10) Pub. No.: US 2007/0139325 A1
(43) Pub. Date: Jun. 21, 2007

(54) Adaptive pre-write for colour sequential lcd driving

(75) Inventor: Jacobus Maria Antonius Van Den Eerenbeemd, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,249

(22) PCT Filed: Feb. 24, 2005
(86) PCT No.: PCT/IB05/50669

§ 371 Date: Aug. 22, 2006

(30) Foreign Application Priority Data
Mar. 4, 2004 (EP) 04100878.0

(51) Int. Cl. G09G 3/36

(52) U.S. Cl. 345/88

(57) ABSTRACT

This invention relates to a system (100) for adaptively driving a coloured liquid crystal display (102) displaying a sequence of images. The system (100) comprises driving electronics (106) for supplying a driving voltage for each pixel in the display (102), a frame memory (116) for storing a first image of the sequence of images, which first image is presently displayed on said display (102). In addition, the system (100) comprises a look-up table (110) for generating a pre-write signal (108) for the driving electronics (106) based on the first image in the frame memory (116) and a subsequent image to be displayed on the display (102).

### FIELD OF INVENTION

This invention relates to system for adaptively driving a liquid crystal display (LCD). In particular, this invention relates to a pixel voltage controller.

### BACKGROUND OF INVENTION

In driving a LCD panel the switching from white to black is faster than the switching from black to white (relaxation). Thus when driving a LCD panel with a coloured sequential projection, such as a series of images, this switching behaviour causes colour cross talk since the applied voltage of the present colour of a pixel influences the switching speed for stepping to the next colour of the pixel. To overcome this problem a pre-write state or a blanking pulse, i.e. an auxiliary signal resetting the pixels prior to each new addressing with display data, such as described in American patent no. U.S. Pat. No. 6,320,565, may be utilised. The American patent discloses a system in which the pixels are reset to a dark state or light state prior to storing subsequent video data. By applying a reset pulse to an entire row of pixels a predetermined number of rows in advance of the row being updated with new video data, eliminates any memory of previously stored information provided that the time between the reset and update exceeds settling time.

The prior art technology still introduces significant delays in driving each pixel between two colours, since by driving the pixels with an output voltage so as to generate a dark or light state prior to updating the system with video data provides an insufficient reduction of the colour cross talk or a loss in brightness.

### SUMMARY OF THE INVENTION

A particular object of the present invention is to provide a system adaptively driving the LCD and to reduce the colour cross talk between images while maintaining brightness.

A particular advantage of the present invention is the provision of a look-up table (LUT) comprising a plurality of pre-write voltages for different situations.

The above object and advantage together with numerous other objects, advantages and features, which will become evident from below detailed description, are obtained according to a first aspect of the present invention as described in the characterizing part of claim 1.

Further embodiments are obtained according to the first aspect of the present invention as described in dependent claims 2-9.

### BRIEF DESCRIPTION OF THE DRAWING

The above, as well as additional objects, features and advantages of the present invention, will be better understood through the following illustrative and non-limiting detailed description of preferred embodiments of the present invention, with reference to the appended drawing, wherein:

FIG. 1a shows a graph of brightness as a function of applied voltage, and FIGS. 1b to 1e show graphs of brightness as functions of time, and

FIG. 2, shows a block diagram of a system according to the preferred embodiment of the present invention, which system is for adaptively drive a LCD panel.

### DETAILED DESCRIPTION OF PREFERRED EMBODIMENTS

In the following description of the various embodiments, reference is made to the accompanying drawing which form a part hereof, and in which are shown by way of illustration various embodiments, in which the invention may be practiced. It is to be understood that other embodiments may be utilized, and structural and functional modifications may be made without departing from the scope of the present invention.

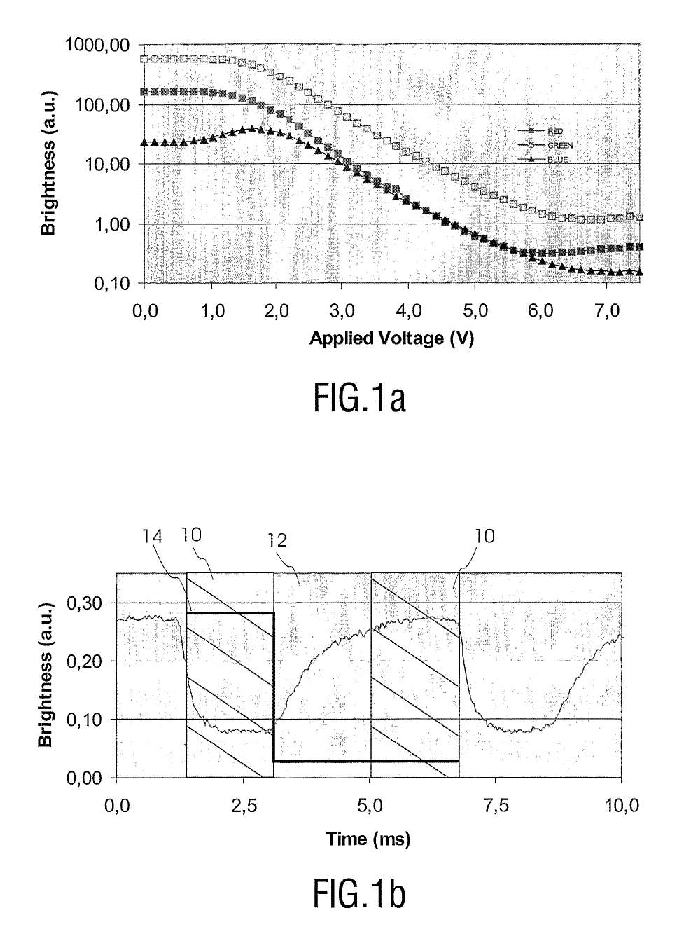

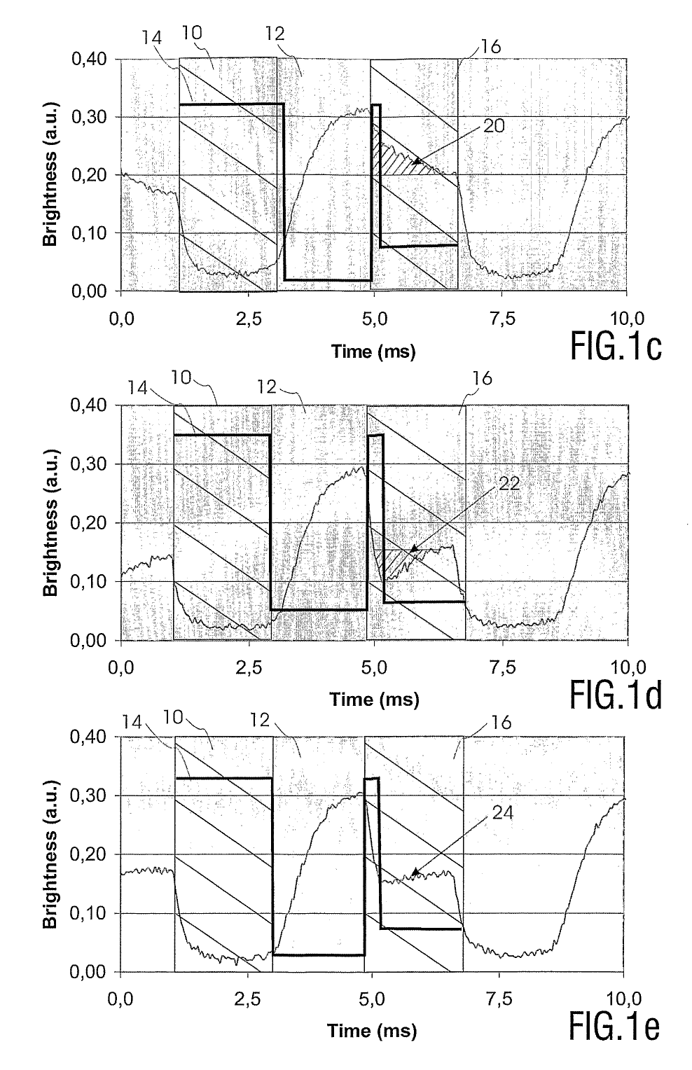

FIG. 1a, shows a graph of brightness as a function of applied voltages for different colours. A minimum voltage or threshold voltage (approximately 1.5V in FIG. 1a) is required to achieve a response from a liquid crystal material. The brightness saturates at higher voltages (approximately 6V in FIG. 1a) and between threshold and saturation the brightness behaves linearly as a function of applied voltage.

FIGS. 1b to 1e, show graphs of the dynamics of liquid crystal materials. FIG. 1a, shows a general liquid crystal displays switching between white 10 and dark 12 light controlled by a control signal 14. The switching rate for switching from white 10 to dark 12 is faster than the switching rate for switching from dark 12 to white 10.

FIG. 1b, shows switching from white 10 to dark 12 to an intermediate 16 brightness. Even the switching rate for switching from dark 12 to the intermediate 16 is slower than the switching rate for switching from white 12 to dark 10.

FIG. 1c, shows switching between white 10 and dark 12 and intermediate 16 brightness utilising a pre-write sequence, which is identical for all columns of a liquid crystal display. As indicated in FIG. 1c the pre-write provides an insufficient reduction of colour cross talk indicated by area 20 or a big loss in brightness as shown as area 22 in FIG. 1d.

FIG. 1e, shows switching between white 10 and dark 12 and intermediate 16 brightness utilising a pre-write sequence according to the present invention. The pre-write sequence is adaptive to changes in brightness. The pre-write sequence comprises writing driving voltages pixels of the liquid crystal display, which driving voltages are determined from a sequence of video signals. The area 24 indicates the obtained cross talk reduction with minimal loss in brightness.

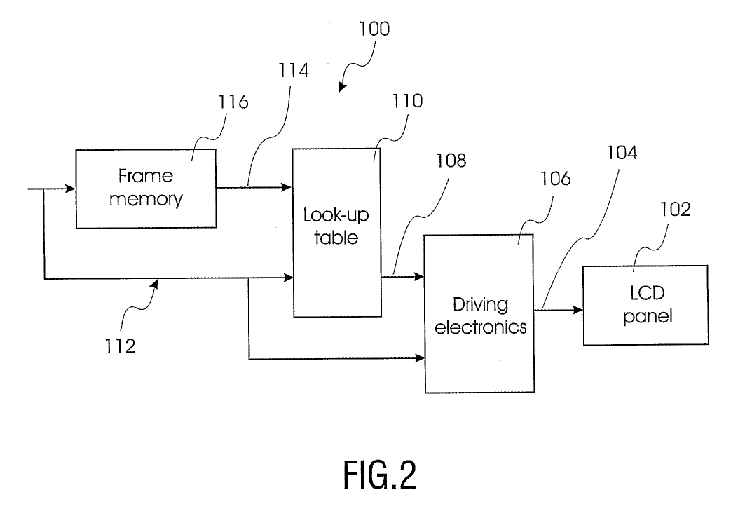

FIG. 2, shows a system for adaptively driving a LCD panel designated in entirety by reference numeral 100. The system 100, which is the preferred embodiment of the present invention, comprises a LCD panel 102 for presenting images to a viewer. The LCD panel 102 is driven by drive signals 104 communicated to the LCD panel by drive electronics 106. The drive signal 104 is a plurality of voltage signals for each pixel in the LCD panel 102, which pixels generally are configured in rows and columns. The voltage signals are controlled by the drive electronics 106 in accordance with, firstly, a pre-write signal 108 communicated to the drive electronics 106 by a look-up table (LUT) 110 and, secondly, in accordance with a video signal 112 communicated from a image generating means such as an image processor.

The pre-write signal 108 establishes a background voltage for each pixel in the LCD panel 102. The pre-write signal 108 thus ensures that the shifting of images, i.e. changing pixel voltages, is performed without substantial cross talk between images.

The look-up table 110 comprises a matrix of pre-write values relating to each pixel's presently required output voltage and to each pixel's following required output voltage. The terms “presently” and “following” are in this context to be construed as current and subsequent, i.e. the presently required voltage for driving a pixel in accordance with a first image and the following required voltage for driving the pixel in accordance with a subsequent image. Each pixel's presently required output voltage is communicated to the look-up table 110 through a communication channel 114 interconnecting the look-up table 110 with a frame memory 116.

The frame memory 116 operates as a shift register for shifting video signals between images. A first video signal 112 is temporarily stored in the frame memory 116, and when a subsequent or second video signal is received at the frame memory 116, the first and second video signals 112 are communicated to the look-up table 110, and the look-up table 110 determines, on the basis of the first and second video signals 112, the value of each pixel's pre-write signal 108, i.e. each pixel's background voltage.

The term “background voltage” is in this context to be construed as an intermediate voltage applied in preparing each pixel of the LCD panel 102 for the subsequent image.

Hence the system 100 according to the preferred embodiment of the present invention utilises multiple images to generate a pre-write value for each pixel in the LCD panel 102.

In a first embodiment of the present invention the system 100 utilises each output voltage for each pixel in a first image presented on the LCD panel 102 and each output voltage for each pixel in a second image to be presented on the LCD panel 102, to derive a pre-write voltage for each pixel. In the first embodiment the pre-write voltage is based on an average of the present output voltage for each pixel and the subsequent output voltage for each pixel.

In a second embodiment of the present invention the system 100 utilises each output voltage for a selected number of pixels in a first image presented on the LCD panel 102 and each output voltage for the same pixels in a second image to be presented on the LCD panel 102, to derive a pre-write voltage for the selected pixels. This provides a significantly improved colour cross talk reduction with minimal loss in brightness. The selected number of pixels may be specific pixel lines of the LCD panel 102. Experiments have shown that the driving voltage from the driving electronics 106 to the number of pixels may advantageously be selected as the maximum driving voltage for achieving a grey level in the range between 20% to 50%.

In addition, the look-up table 110 according to the second embodiment of the present invention comprises a first matrix of pre-write signals for the selected pixels for a darkening sequence of images and a second matrix of pre-write signals for the selected pixel for a lightening sequence of images. In this fashion the non-linearity between changing the pixels from dark to light and changing the pixels from light to dark is compensated.

1. A system for adaptively driving a coloured liquid crystal display (102) for displaying a sequence of images, and comprising driving electronics (106) for supplying a driving voltage for each pixel in said display (102) and characterized in further comprising a frame memory (116) for storing a first image of said sequence of images, which first image is presently displayed on said display (102), and a look-up table (110) for generating a pre-write signal (108) for said driving electronics (106) based on said first image in said frame memory (116) and a subsequent image to be displayed on said display (102).

2. A system according to claim 1, wherein said look-up table (110) is operable to generate a pre-write signal (108) for said driving electronics (106) based on a difference between pixel voltages of said first and of said subsequent image to be displayed on said display (102).

3. A system according to claim 1, wherein said look-up table (110) comprising a general matrix of predefined pre-write signals and is operable to select a pre-write signal (108) from said predefined pre-write signals based on pixel voltages of said first and of said subsequent image to be displayed on said display (102), and is operable to communicate said predefined pre-write signals (108) to said driving electronics (106).

4. A system according to claim 1, wherein said driving electronics (106) is operable to generate a background driving voltage signal for pixels in said LCD panel (102) after generating a driving voltage for pixels in said LCD panel (102) in accordance with said first image.

5. A system according to claim 1, wherein said look-up table (110) is adapted to generate said pre-write signal (108) based on pixel voltages of selected pixels in said first and subsequent image.

6. A system according to claim 5, wherein said selected number of pixels comprise a line of pixels in said first and subsequent image.

7. A system according to claim 4, wherein said predefined pre-write signals enable said driving electronics (108) to generate a background driving voltages for pixels in a grey-level in the range between 20% to 50%.

8. A system according to claim 1, wherein said look-up table (110) is operable to generate a first pre-write signal for said driving electronics (106), when a difference between a driving voltage for a pixel of said first image and said subsequent image is negative and is operable to generate a second pre-write signal for said driving electronics (106), when said difference is positive.

9. A system according to claim 8, wherein first pre-write signal enables said driving electronics (106) to generate a driving voltage having a short time duration for said pixel and wherein said second pre-write signal enables said driving electronics (106) to generate a driving voltage having a longer time duration.
